(19) United States
(12) Patent Application Publication
(10) Pub. No.: US 2003/0097654 A1
(43) Pub. Date: May 22, 2003

(54) System and method of geographic authorization for television and radio programming distributed by multiple delivery mechanisms

(76) Inventors: Kenneth A. Franken, Iowa City, IA (US); Jack Perry, Cedar Rapids, IA (US)

Correspondence Address: SIMMONS, PERRINE, ALBRIGHT & ELLWOOD, P.L.C., THIRD FLOOR TOWER PLACE, 22 SOUTH LINN STREET, IOWA CITY, IA, 52240, US

(21) Appl. No.: 09/681,845

(22) Filed: Jun. 15, 2001

Related U.S. Application Data
(63) Continuation-in-part of application No. 09/538,215, filed on Mar. 30, 2000, now Pat. No. 6,252,547.
Application No. 09/538,215 is a continuation-in-part of application No. 09/092,128, filed on Jun. 5, 1998, now Pat. No. 6,147,642.

(51) Int. Cl. H04N 7/16

(52) U.S. Cl. 725/1

(57) ABSTRACT

A system for authorizing reception, via multiple signal distribution mechanisms including: satellite, cable, internet, broadcast, etc. by a consumer at a first location, of programming content based upon numerous criteria, including a signal strength calculator, a distance from a point calculator, and a GIS boundary computer, the system including an authorization server making repetitive authorization determinations and providing a location specific authorized content list for the first location.

### CROSS REFERENCE TO RELATED APPLICATIONS

The present invention is a continuation-in-part application of a co-pending application entitled “METHOD AND APPARATUS FOR LIMITING ACCESS TO SIGNALS DELIVERED VIA THE INTERNET” having Ser. No. 09/538,21 filed on Mar. 30, 2000, which itself is a continuation-in-part application of an application having Ser. No. 09/092,128 which was entitled METHOD AND APPARATUS FOR LIMITING ACCESS TO INTERNET COMMUNICATION SIGNALS” filed on Jun. 5, 1998, and now issued as U.S. Pat. No. 6,147,642; the contents of these applications and patents are incorporated herein in their entirety by this reference.

### BACKGROUND OF INVENTION

In recent months, it has been rapidly becoming more commercially feasible to provide broadcast television to consumers in real time via the Internet. Increasing bandwidth and advances in video compression technology make it technologically possible to stream VCR quality video to consumers today. Soon it is expected that nearly all Americans will have the technology which could be made to receive television via the Internet.

While Internet delivery of television programming has been done in the past, it does have some drawbacks. The most salient of these drawbacks is that Internet delivery of broadcast television programming is alleged to be in violation of the U.S. copyright laws. American television is based on the network-affiliate distribution system. In essence, the networks typically supply general-interest programming, and their local affiliates supplement this with local-interest programming and syndicated content. A mix of local and national advertising sales often funds the system. The system has worked well for many years. Localism and local origination of programming have been central features of the system of regulation broadcast television in this country.

Fundamental to this model is the territorial exclusivity granted to the local affiliates. Prior to cable TV, territorial exclusivity was enforced via FCC transmitter licensing. With the advent of new delivery mechanisms for television, Congress has given cable and satellite TV services permission to retransmit broadcast TV channels under a compulsory license; but those rights limit retransmissions to a specific geographic area to prevent broadcasts from one city from “eating” into the audience of programs in another. Cable carriage rules are largely designed to replicate broadcast television signal areas.

Television delivery via the Internet as it currently exists, with its global free access characteristics, challenges these well-established territorial restrictions.

Similarly, radio shares much of the same territorial broadcast exclusivity of television.

Consequently, there exists a need for improved methods and systems for delivery of television and radio programming via the Internet.

### SUMMARY OF INVENTION

It is an object of the present invention to provide a system and method for delivering television and radio programming via the Internet.

It is a feature of the present invention to utilize a viewer/listener authorization scheme which authorizes delivery of broadcasts to those geographic locations which meet certain predetermined criteria.

It is another feature of the present invention to include signal strength prediction technology to calculate the availability of broadcast signals, via an antenna at a particular declared location.

It is yet another feature of the present invention to include a programmable Internet viewer authorization scheme which includes a variable business rule scheme for using geographic limitations in authorizing access to television and radio broadcast via the Internet.

It is an advantage of the present invention to achieve geographically limited authorization of television and radio programming via the Internet.

The present invention is an apparatus and method for authorizing Internet delivery of television/radio programming which is designed to satisfy the aforementioned needs, provide the previously stated objects, include the above-listed features, and achieve the already articulated advantages. The present invention is carried out in a non-global consuming area manner in a sense that the geographic viewing/listening area of television programming is authorized only to limited consumers located in positions which are computed to have a predetermined relationship with a predetermined criteria for viewer/listener authorization.

Accordingly, the present invention is a system and method including an Internet viewer/listener location authorization scheme which provides a limited authorization of viewers based upon their geographic location with respect to predetermined authorization limitations.

### BRIEF DESCRIPTION OF DRAWINGS

The invention may be more fully understood by reading the following description of the preferred embodiments of the invention, in conjunction with the appended drawings wherein:

FIG. 1 is a block diagram of the major functional components of a television/radio programming delivery authorization system of the present invention.

### DETAILED DESCRIPTION

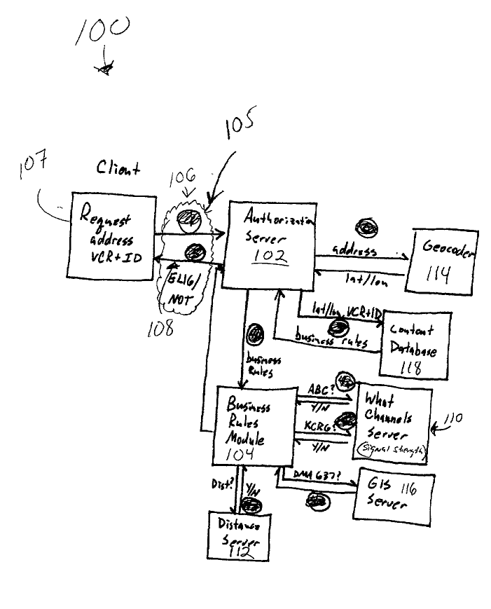

Now referring to the drawings, wherein like numerals refer to like matter throughout, and more specifically to FIG. 1, there is shown a television/radio programming delivery authorization system of the present invention generally designated 100, having an authorization server 102 and a client 107, both of which could be a personal computer or any type of general purpose computer. Authorization server 102 preferably will have a collection of business rules algorithms 104 therein or coupled thereto, for making authorization determinations based upon various criteria, including signal strength and other than signal strength. Authorization server 102 accepts a geographic location and programming request input 106, such as a street address, lat-lon, zip code, or other geographic reference from client 107, via a computer network 105, such as the Internet. Location specific authorized content list and/or individual programming eligibility determination indicator 108 is the result of operation of authorization server 102. In other words, for each geographic location and programming request input 106 provided as an input, the output is a single eligibility determination or a list of programming which is authorized to be received at that location, via various means of delivery. For example, satellite distribution of network television signals are authorized based upon the signal strength of local network affiliates serving the location. This notion of using signal strength as a criteria for authorization of satellite signals is depicted by What Channels Server 110. The above-referenced patent entitled METHOD AND APPARATUS FOR LIMITING ACCESS TO INTERNET COMMUNICATION SIGNALS” filed on Jun. 5, 1998, and now issued as U.S. Pat. No. 6,147,642 describes in detail the function of signal strength calculators in What Channels Server 110. What Channels Server 110 could be used to authorize distribution of television or radio signals via distribution means other than satellite. For example, What Channels Server 110 could be used to authorize distribution of such signals via the Internet based upon signal strength. Details of using signal strength to authorized Internet delivery of television programming is described in the above-referenced patent application entitled; “METHOD AND APPARATUS FOR LIMITING ACCESS TO SIGNALS DELIVERED VIA THE INTERNET” having serial number 09/538,215 filed on Mar. 30, 2000. The present invention is an expansion of these two ideas in that it applies to distribution means other than satellite and internet-delivered programming other than that based solely upon signal strength calculations. The present invention also includes means for authorization of programming delivery over any type of distribution system based upon other non-signal strength criteria, such as by using a distance from a point calculator 112; and a Geographic Information System (GIS) boundary computer 116. In any embodiment it is preferred to include a programming content and business rule database 118 which includes, among other things, a listing of all of the programming content available irrespective of location and means of distribution.

The present invention functions as follows:

Client 107 sends a geographic location and programming request input 106 which is preferably a VCRPlus ID and street address. The VCRPlus ID is assumed to encode information which uniquely identifies the content, the content provider and the content delivery mechanism. VCRPlus is well known in the art and is believed to be readily adaptable to include the above-listed information. VCRPlus is a registered trademark owned by Gemstar Development Corp. of Pasadena, Calif., USA. The client 107 is assumed to have previously validated that the street address provided in the geographic location and programming request input 106 is indeed the location where the programming will be delivered. In an alternate arrangement, another server other than the client 107 could be used to perform the validation. Authorization server 102 will provide the street address in geographic location and programming request input 106 to the location database/geocoder 114 which will return a lat/lon to authorization server 102. Of course, if lat/lon is originally provided in geographic location and programming request input 106 by the client 107, this step is unnecessary. The authorization server 102 then queries the programming content and business rule database 11 8 for business rules which would be applicable to the geographic location and programming request input 106 (the VCRPlus ID and lat/lon). For the purpose of example, it will be assumed that geographic location and programming request input 106 relates to a request for programming which is on the ABC network and provided by local affiliate KCRG, in Cedar Rapids, Iowa, and will be delivered via the Internet. The rules which could be returned by programming content and business rule database 118 could be as follows:

a) content can be delivered via the internet into households where all ABC network signals predicted for the lat/lon returned by location database/geocoder 114 are predicted to be below Grade B by What Channels Server 110. Grade B is a term of art which is well known and used in the determination of eligibility for delivery of network programming via satellite.

b) content can be delivered via the internet into households where the predicted signal strength of local affiliate KCRG is at least Grade B at the lat/lon provided by location database/geocoder 114.

c) content can be delivered into households inside DMA 637 (the DMA serviced by KCRG TV and including Cedar Rapids, Iowa, and surrounding areas).

The business rules algorithms 104 could process the above-listed business rules as follows:

1) for rule a), query the What Channels Server 110 for all ABC stations serving the location with a Grade B or better signal. If the query return is empty, then the request is eligible and the process is stopped.

2) for rule b), query the What Channels Server 10 for the KCRG signal at the location. If the signal is predicted to be at least Grade B, then the request is eligible and the process is stopped. (Note: it may be more practical to combine these first two steps.)

3) for rule c), query the GIS boundary computer 116 for an answer to the question: “Is the location inside of DMA 637?” If the query result is “Yes”, then the request is eligible and the process is stopped. (Note: If the original programming request in geographic location and programming request input 106 were for something different, such as an NFL game in an NFL home city, then the programming content and business rule database 118 may have returned business rules which are not related to signal strength, but to distance from the stadium. In such cases, the distance from a point calculator 112 would be used instead of a signal strength calculator in the What Channels Server 110.)

4) If steps 1-3 do not produce an eligibility determination of “Yes”, then the process is stopped and an “Ineligible” indication is provided in Location specific authorized content list and/or individual programming eligibility determination indicator 108. (Note: the entire process can be repeated for other content request from the location, thereby creating a location specific authorized content list.)

It is believed that various details may be different in the software code used to implement distance from a point calculator 112, location database/geocoder 114 and GIS boundary computer 116, but with the guidance provided by this description, a person skilled in the art could readily construct an authorization system as described and claimed herein which is tailored to the particular needs of any specific application. It is also believed that the number and details of the business rules in programming content and business rule database 118 will vary from application to application and will vary within a single application over time.

The present invention is intended to cover all such applications which a person skilled in the art might implement, with the aid and assistance of the description herein.

It is thought that the method and apparatus of the present invention will be understood from the foregoing description and that it will be apparent that various changes may be made in the form, construction, steps and arrangement of the parts and steps thereof, without departing from the spirit and scope of the invention or sacrificing all of their material advantages. The form herein described is merely a preferred or exemplary embodiment thereof.

1. a system for authorizing broadcast reception comprising:
an authorization server which includes and is adapted and configured by software therein which receives a geographic location and programming request input;
said authorization server further includes a What Channels Server and among other things, is adapted and configured by software to perform a signal strength calculation for a first location of a terrestrial broadcast signal, which is broadcast from a second location, where said signal strength calculation determines that a signal strength of said terrestrial broadcast signal at said first location exceeds a predetermined threshold;
said authorization server further includes a distance from a point calculator which supplies information used for authorization for availability of programming to said first location based upon a geographic calculation that said first location is within a predetermined radius from a third location; said authorization server further coupled to a location database/geocoder which returns a lat/Ion when provided with a street address;
said authorization server further including software and is adapted and configured to provide information used for authorization of programming to said first location if said first location is located in a CIS boundary, as determined by a GIS boundary computer;
a programming content and business rule database which includes a list of programming options which are available over various signal distribution mechanisms to said first location; and includes a plurality of business rules used for authorizing delivery of programming,
said authorization server is adapted and configured to determine eligibility for said geographic location and programming request input and repetitively compute additional requests and thereby provide a location specific authorized content list which is a subset of said programming content database where programming content has been excluded based upon authorization denials determined by said authorization server.

2. A method of authorizing distribution of programming comprising the steps of:
providing a geographic location and programming request to an authorization server;
returning a set of business rules which are stored in a database;
wherein said set of business rules are selected from said database based upon both a geographic location component and a programming component of said geographic location and programming request, and said database includes at least one business rule which is not based solely upon a signal strength of a terrestrially broadcast signal; and,
processing said set of business rules to generate an indication of eligibility of reception of programming.

3. A method of claim 2 wherein said geographic location and programming request includes a first street address and said authorization server is coupled to a location database/geocoder, which is adapted and configured to generate a first lat/lon reference which corresponds to said first street address.

4. A method of claim 2 wherein said geographic location and programming request includes a postal zip code, and said authorization server is coupled to a location database/geocoder, which is adapted and configured to generate a first lat/lon reference which corresponds to said postal zip code.

5. A method of claim 3 wherein said set of business rules includes a software algorithm which relates to distance from a point calculation which analyzes a distance separation between said first street address and a second geographic location.

6. A method of claim 5 wherein said second geographic location is a stadium which is adapted and configured for playing football games therein.

7. A method of claim 5 wherein said programming component of said geographic location and programming request is a request for programming of a live football game being performed in said stadium.

8. A method of claim 3 wherein said set of business rules includes a software algorithm which relates to inclusion of said first street address in a first GIS boundary.

9. A method of claim 8 wherein said first GIS boundary is a DMA.

10. A method of claim 3 wherein said set of business rules includes a software algorithm which relates to predicting a signal strength of a first terrestrially broadcast signal carrying first programming content to said first street address and said programming component of said geographic location and programming request is a local television station news broadcast;
wherein said step of processing said set of business rules results in an eligibility indication when said signal strength exceeds a predetermined threshold.

11. A system comprising:
a world-wide computer network;
a client computer disposed at a first location and coupled via an internet connection to said world-wide computer network;
said client adapted and configured via software therein to generate geographic location and programming requests;
an authorization server, coupled to said world-wide computer network;
said authorization server adapted and configured with software accessible thereto, to make an eligibility determination relating to delivery of programming to said client computer via said world-wide network;
said authorization server using a What Channels Server with a signal strength calculator for predicting a strength of a terrestrial broadcast signal at said first location;
said authorization server using a distance from a point calculator to determine a separation of said first location from a geographic location of a stadium which is adapted and configured to be used for sporting events.

12. A system for authorizing reception of communication signals comprising:
an authorization server which includes and is adapted and configured by software therein which receives a geographic location and programming request input;
said authorization server further includes a first component which is adapted and configured by software to perform a signal strength calculation for a first location of a terrestrial broadcast signal, which is broadcast from a second location, where said signal strength calculation determines that a signal strength of said terrestrial broadcast signal at said first location exceeds a predetermined threshold;
said authorization server further includes a distance from a point calculator which supplies information used for authorization for availability of programming to said first location based upon a geographic calculation that said first location is within a predetermined radius from a third location;
said authorization server further coupled to a location database/geocoder which returns a lat/lon when provided with a street address;
said authorization server further including software and is adapted and configured to provide information used for authorization of programming to said first location if said first location is located in a predetermined first boundary, as determined by a boundary computer;
a programming content and signal authorization algorithm database which includes a list of programming options which are available over various signal distribution mechanisms to said first location; and includes a plurality of predetermined signal authorization algorithms used for authorizing delivery of programming; and
said authorization server is adapted and configured to determine eligibility for said geographic location and programming request input and repetitively compute additional requests and thereby provide a location specific authorized content list which is a subset of said programming content database where programming content has been excluded based upon authorization denials determined by said authorization server.

13. A method of authorizing distribution of programming comprising the steps of:
providing a geographic location and programming request to an authorization server;
returning a set of predetermined signal authorization algorithms which are stored in a database;
wherein said set of predetermined signal authorization algorithms are selected from said database based upon both a geographic location component and a programming component of said geographic location and programming request, and said database includes at least one predetermined signal authorization algorithm which is not based solely upon a signal strength of a terrestrially broadcast signal; and,
processing said set of predetermined signal authorization algorithms to generate an indication of eligibility of reception of programming.

14. A method of claim 13 wherein said programming is television programming.

15. A method of claim 13 wherein said programming is radio programming.

16. A system of claim 12 wherein said programming content database contains radio programming.

17. A system of claim 12 wherein said programming content database contains television programming.
